(19) United States
(12) Patent Application Publication
(10) Pub. No.: US 2020/0089087 A1
(43) Pub. Date: Mar. 19, 2020

(54) INTERCHANGEABLE LENS STORAGE CASE, CAP AND INTERCHANGEABLE LENS STORAGE CASE SYSTEM

(71) Applicant: OLYMPUS CORPORATION, Tokyo (JP)

(72) Inventor: Akira IWADARE, Tokyo (JP)

(73) Assignee: OLYMPUS CORPORATION, Tokyo (JP)

(21) Appl. No.: 16/564,480

(22) Filed: Sep. 9, 2019

(30) Foreign Application Priority Data
Sep. 18, 2018 (JP) 2018-174200

(51) Int. Cl. G03B 17/56

(52) U.S. Cl. CPC G03B 17/568; G03B 17/14

(57) ABSTRACT

An interchangeable lens storage case for storing an interchangeable lens using a cap mounted in one-end portion of the interchangeable lens includes: a case main body; and a first lid member positioned and fixed to an aperture of the case main body. The first lid member includes an aperture passing through the one-end portion of the interchangeable lens, and a reception portion pressed and fixed to the interchangeable lens in an outer peripheral portion of the aperture. The reception portion is fixed by being interposed between the interchangeable lens and the cap when the cap is fixed to the interchangeable lens.

This application is based upon and claims the benefit of priority from Japanese Patent Application No. 2018-174200, filed on Sep. 18, 2018, the entire contents of which are incorporated herein by reference.

### BACKGROUND

The present disclosure relates to an interchangeable lens storage case, a cap and interchangeable lens storage case system.

In a lens storage case of an interchangeable lens which is detachably attached to an image capture device, an annular lid body detachably attached to an aperture of a cylindrical case body, and a lens cap which is detachably attached to a circular aperture of the lid body and attached to the interchangeable lens are provided in a lid which closes the aperture of the case body so as to reduce a labor when removing the lens cap from the interchangeable lens (for example, Japanese Patent No. 3903595).

### SUMMARY

According to one aspect of the present disclosure, there is provided an interchangeable lens storage case for storing an interchangeable lens using a cap mounted in one-end portion of the interchangeable lens, the interchangeable lens storage case including: a case main body; and a first lid member positioned and fixed to an aperture of the case main body, the first lid member including an aperture passing through the one-end portion of the interchangeable lens, and a reception portion pressed and fixed to the interchangeable lens in an outer peripheral portion of the aperture, wherein the reception portion is fixed by being interposed between the interchangeable lens and the cap when the cap is fixed to the interchangeable lens.

The above and other features, advantages and technical and industrial significance of this invention will be better understood by reading the following detailed description of presently preferred embodiments of the disclosure, when considered in connection with the accompanying drawings.

### BRIEF DESCRIPTION OF THE DRAWINGS

FIG. 1 is an assembly perspective view of an interchangeable lens storage case system according to a first embodiment;

FIG. 2 is a perspective view schematically illustrating a configuration of the interchangeable lens storage case system according to the first embodiment;

FIG. 3 is a cross-sectional view taken along line III-III of FIG. 2;

FIG. 4 is a top view of the lens storage case;

FIG. 5 is a cross-sectional view taken along line V-V of FIG. 4;

FIG. 6 is a top view of a buffer member;

FIG. 7 is a cross-sectional view taken along line VII-VII of FIG. 6;

FIG. 8 is a diagram illustrating the state of FIG. 7 compressed in a vertical direction;

FIG. 9 is a top view of a first lid member;

FIG. 10 is a cross-sectional view taken along line X-X of FIG. 9;

FIG. 11 is a top view of the mount cap;

FIG. 12 is a side view of the mount cap;

FIG. 13 is a perspective view schematically illustrating the mount cap;

FIG. 14 is a perspective view when the mount cap is stored in the first lid member;

FIG. 15 is a perspective view when the mount cap is stored in the first lid member;

FIG. 16 is a cross-sectional view taken along line XVI-XVI of FIG. 15;

FIG. 17 is a cross-sectional view of the interchangeable lens storage case system according to a first modification of the first embodiment;

FIG. 18 is an assembly perspective view of an assembly perspective view of the interchangeable lens storage case system according to a second embodiment;

FIG. 19 is a perspective view schematically illustrating a configuration of the interchangeable lens storage case system according to the first embodiment;

FIG. 20 is a cross-sectional view taken along line XX-XX of FIG. 19;

FIG. 21 is a top view of the first lid member;

FIG. 22 is a cross-sectional view taken along line XXII-XXII;

FIG. 23 is a perspective view when the mount cap is stored in the first lid member;

FIG. 24 is a cross-sectional view when the mount cap is stored in the first lid member;

FIG. 25 is a perspective view when the mount cap is stored in the first lid member; and

FIG. 26 is a cross-sectional view for schematically describing a buffer member according to a modification of the first and second embodiments.

### DETAILED DESCRIPTION

Hereinafter, embodiments of this disclosure will be described in detail together with the drawings. Further, this disclosure is not limited to the following embodiments. In addition, shapes, sizes, and positional relation in the drawings referred in the following description are schematically illustrated in order to help with understanding on the content of this disclosure. In order words, this disclosure is not limited only to the shapes, the sizes, and the positional relation illustrated in the drawings. Further, the following description will be given about an example of the lens storage case which stores an interchangeable lens which is detachably attached to an image capture device (main body).

### First Embodiment

Configuration of Lens Storage Case System

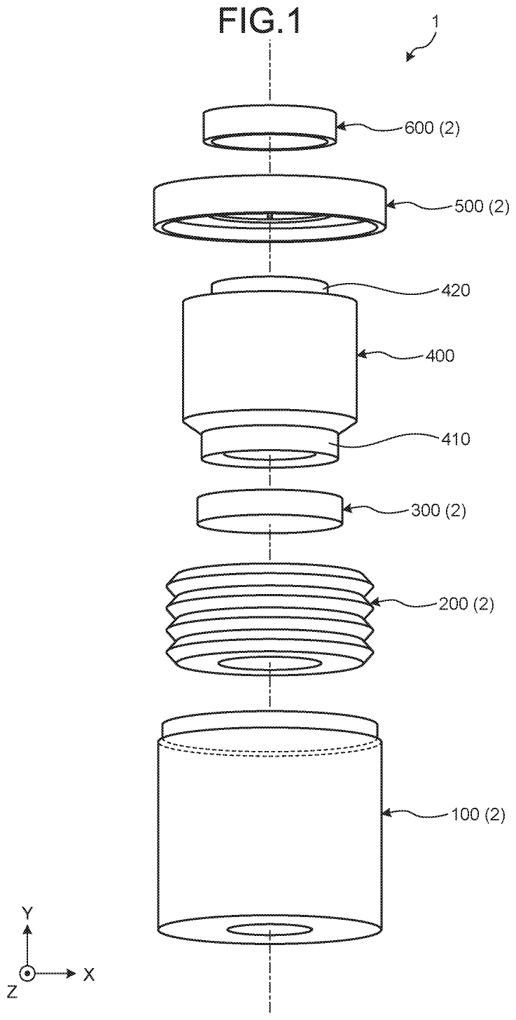

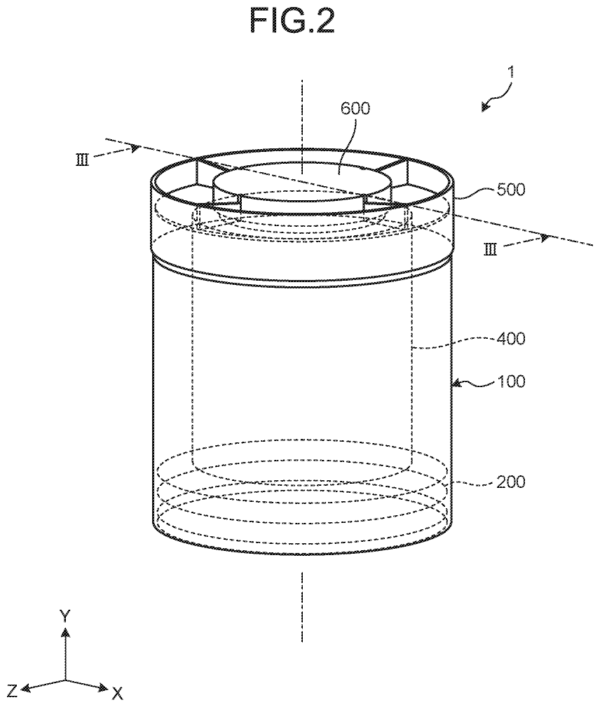

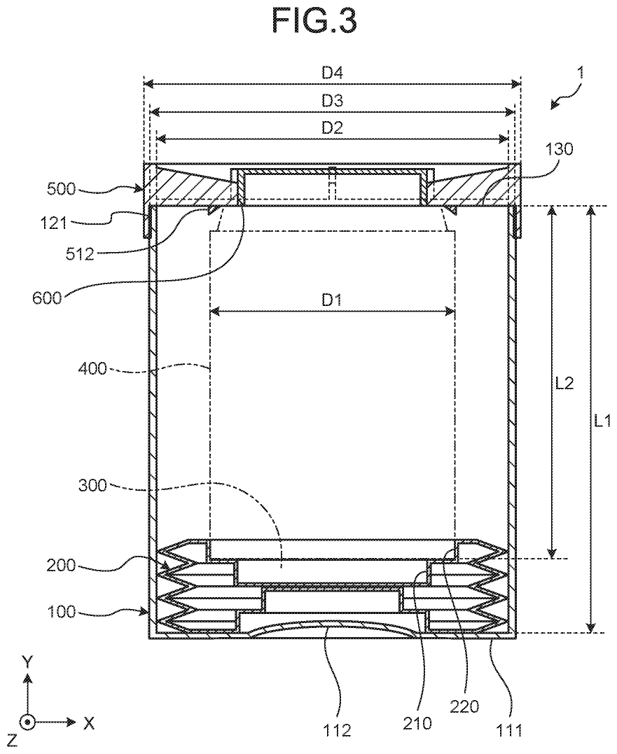

FIG. 1 is an assembly perspective view of an assembly perspective view of the interchangeable lens storage case system according to a first embodiment. FIG. 2 is a perspective view schematically illustrating a configuration of the interchangeable lens storage case system according to the first embodiment. FIG. 3 is a cross-sectional view taken along line III-III of FIG. 2.

An interchangeable lens storage case system 1 illustrated in FIGS. 1 to 3 includes an interchangeable lens storage case 2, and an interchangeable lens 400 which can be stored in the interchangeable lens storage case 2. In addition, the interchangeable lens storage case 2 includes a case main body 100, a buffer member 200, a lens cap 300, a first lid member 500, and a mount cap 600.

Configuration of Case Main Body

First, the configuration of the case main body 100 will be described.

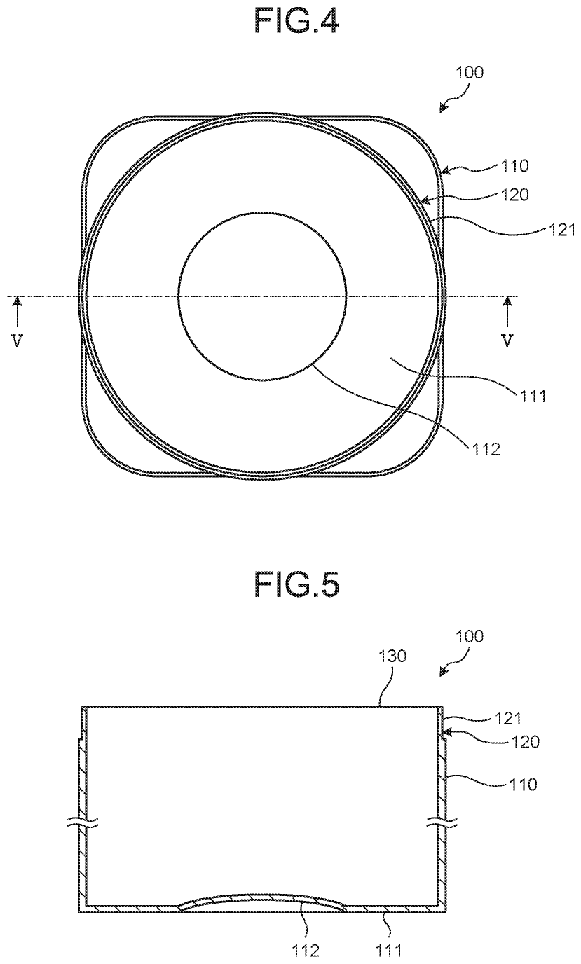

FIG. 4 is a top view of the case main body 100. FIG. 5 is a cross-sectional view taken along line V-V of FIG. 4.

The case main body 100 illustrated in FIGS. 1 to 5 is formed of a transparent member. The case main body 100 is formed such that the length L1 in a longitudinal direction (depth direction) is larger than the length L2 in a longitudinal direction (optical axis direction) of the interchangeable lens 400. In addition, the case main body 100 includes a casing 110 of a bottomed rectangular shape and a cylindrical fitting portion 120 to which the first lid member 500 is fitted. The casing 110 and the fitting portion 120 are integrated by injection molding.

The casing 110 includes a regulation portion 112 in a bottom 111. The regulation portion 112 is formed in a convex shape toward an aperture 130, and regulates that the buffer member 200 moves inside. Further, the shape of the regulation portion 112 may be appropriately changed, and may be an annular shape for example. Further, in the first embodiment, the shape of the casing 110 is illustrated as a rectangular shape, but may be appropriately changed. The shape may be the same shape, cylindrical shape, as the fitting portion 120. In addition, the member forming the case main body 100 is not necessarily transparent, but may be appropriately changed. In addition, the length L1 of the longitudinal direction of the case main body 100 may be appropriately changed as long as larger than the length L2 of the longitudinal direction of the interchangeable lens 400.

The fitting portion 120 is provided on the outer peripheral side of the aperture 130, and includes a groove 121 to which the first lid member 500 is freely fitted.

Configuration of Buffer Member

Next, the configuration of the buffer member 200 will be described.

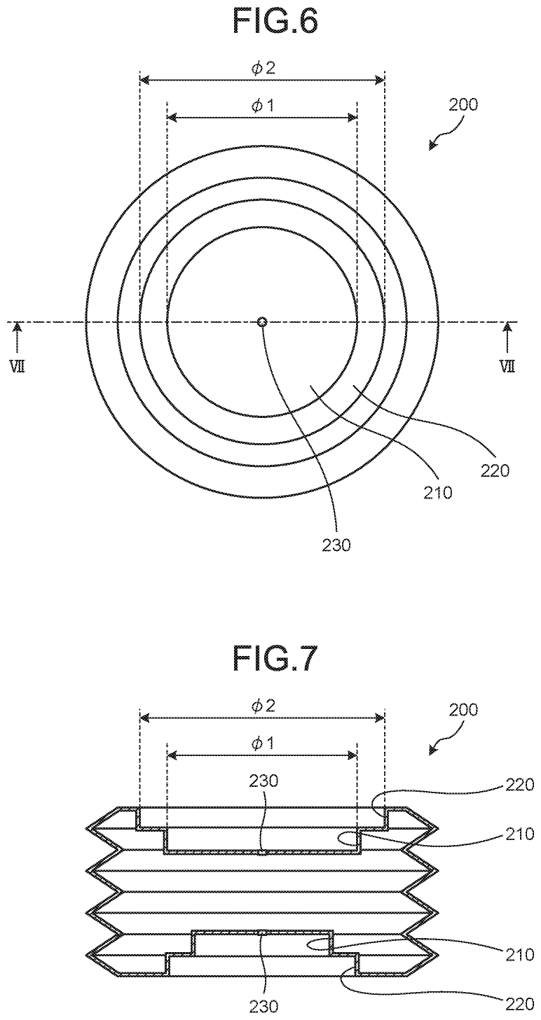

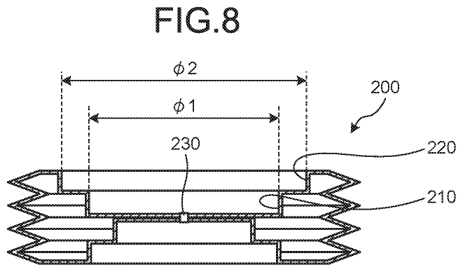

FIG. 6 is a top view of a buffer member 200. FIG. 7 is a cross-sectional view taken along line VII-VII of FIG. 6. FIG. 8 is a diagram illustrating the state of FIG. 7 compressed in a vertical direction.

As illustrated in FIGS. 1 to 3 and FIGS. 6 to 8, the buffer member 200 is disposed between the bottom 111 of the case main body 100 and the other-end portion side (lens side) of the interchangeable lens 400. The buffer member 200 is folded by a predetermined amount to change its dimension based on a dimension between the bottom 111 of the case main body 100 and the other-end portion side (lens side) of the interchangeable lens 400. Specifically, the buffer member 200 is formed in a bellows shape, and is provided tightly to the bottom 111 of the case main body 100. The buffer member 200 biases the interchangeable lens 400 toward the first lid member 500 when the interchangeable lens 400 is stored in the case main body 100. The buffer member 200 includes a first lens receiving portion 210, a second lens receiving portion 220, and a hole 230.

The first lens receiving portion 210 and the second lens receiving portion 220 each are provided above and below the buffer member 200. The first lens receiving portion 210 is formed in a cylindrical shape, and has an inner diameter R1 of ϕ1. In addition, the second lens receiving portion 220 is formed in a cylindrical shape, and has an inner diameter R2 of ϕ2 (ϕ2>ϕ1).

The buffer member 200 thus configured is provided with the lens cap 300 which is mounted in the interchangeable lens 400 described below, and prevents the interchangeable lens 400 from moving in the case main body 100. In this case, the buffer member 200 is compressed by pushing out the air from the hole 230 when the interchangeable lens 400 is biased toward the first lid member 500 (FIGS. 7 and 8). As a result, the buffer member 200 serves as a buffer material. Further, in FIGS. 6 to 8, the number of holes 230 is set to one, but may be appropriately changed, and the holes may be provided in a plurality of places for example.

Configuration of Lens Cap

Next, the lens cap 300 will be described.

The lens cap 300 illustrated in FIGS. 1 to 3 is formed in a disk-like shape, and detachably mounted with respect to an other-end portion 410 on an object side (lens side) in the optical axis direction (longitudinal direction) of the interchangeable lens 400. The lens cap 300 is stored in the first lens receiving portion 210 or the second lens receiving portion 220 of the buffer member 200. Further, the diameter of the lens cap 300 is appropriately changed according to the diameter of the mounted interchangeable lens 400.

Configuration of Interchangeable Lens

Next, the interchangeable lens 400 will be described. The interchangeable lens 400 illustrated in FIGS. 1 to 3 is detachably provided in an image capture device (not illustrated). The interchangeable lens 400 is configured such that the lens cap 300 is detachably mounted to the other-end portion 410 on the object side (lens side) in the optical axis direction (longitudinal direction). In addition, the interchangeable lens 400 is configured such that the mount cap 600 is detachably mounted to one-end portion 420 (hereinafter, simply referred to as “mount portion 420”) on a mount side in the optical axis direction (longitudinal direction).

Configuration of First Lid Member

Next, the configuration of the first lid member 500 will be described.

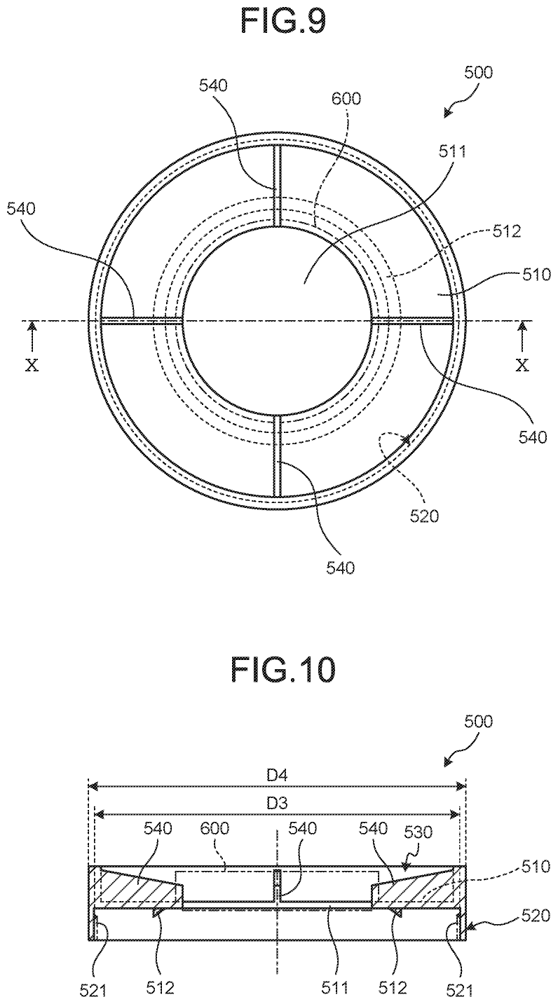

FIG. 9 is a top view of the first lid member 500. FIG. 10 is a cross-sectional view taken along line X-X of FIG. 9.

The first lid member 500 illustrated in FIGS. 1 to 3 and FIGS. 9 and 10 is detachably mounted to the aperture 130 of the case main body 100. The first lid member 500 has an inner diameter D2 larger than an outer diameter D1 of the interchangeable lens 400. The first lid member 500 is provided with an aperture 511 through which the mount portion 420 of the interchangeable lens 400 passes, and a reception portion 510 which is provided in the outer peripheral portion of the aperture 511 and is brought into press-fixing to the interchangeable lens 400, and positioned and fixed to the aperture 130 of the case main body 100. In addition, the first lid member 500 includes a positioning portion 520 to be positioned in the case main body 100. Further, the first lid member 500 includes a storage portion 530 which stores the mount cap 600. The reception portion 510, the positioning portion 520, and the storage portion 530 are integrated by injection molding.

The reception portion 510 is an annular shape of which the outer diameter D4 is larger than the outer diameter D1 of the interchangeable lens 400. The reception portion 510 includes the aperture 511 through which the mount portion 420 of the interchangeable lens 400 passes freely. The reception portion 510 abuts on and fixed to the interchangeable lens 400. The aperture 511 has the inner diameter which is almost matched to the outer diameter of an annular portion 620 of the mount cap 600 described below. In addition, the reception portion 510 includes an annular regulation portion 512 which regulates the movement of the interchangeable lens 400 when the interchangeable lens 400 abuts on the rear surface side. The regulation portion 512 has the inner diameter which is almost matched to the outer diameter of the mount portion 420 of the interchangeable lens 400.

The positioning portion 520 is provided on the rear surface side of the reception portion 510, and is fitted to the case main body 100. The positioning portion 520 is formed in a cylindrical shape, and includes a groove 521 which is fitted to a groove 104 of the case main body 100. The positioning portion 520 has the inner diameter which is almost matched to an outer diameter D3 of the case main body 100.

The storage portion 530 is formed in a cylindrical shape, and is provided on the surface side of the reception portion 510. The storage portion 530 stores the mount cap 600 described below. The storage portion 530 includes a rib 540 which guides the mount cap 600 to a predetermined position, and performs a rotation stop of the mount cap 600. The ribs 540 are provided in a predetermined interval (for example, 90 degrees) in the storage portion 530. The rib 540 is obliquely provided from the outer edge toward the center of the storage portion 530.

Configuration of Mount Cap

Next, the configuration of the mount cap 600 will be described.

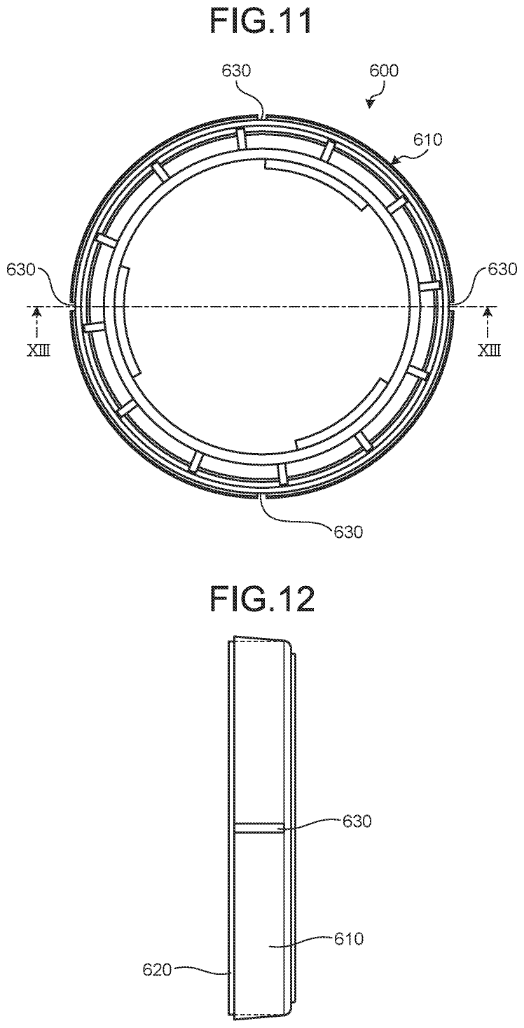

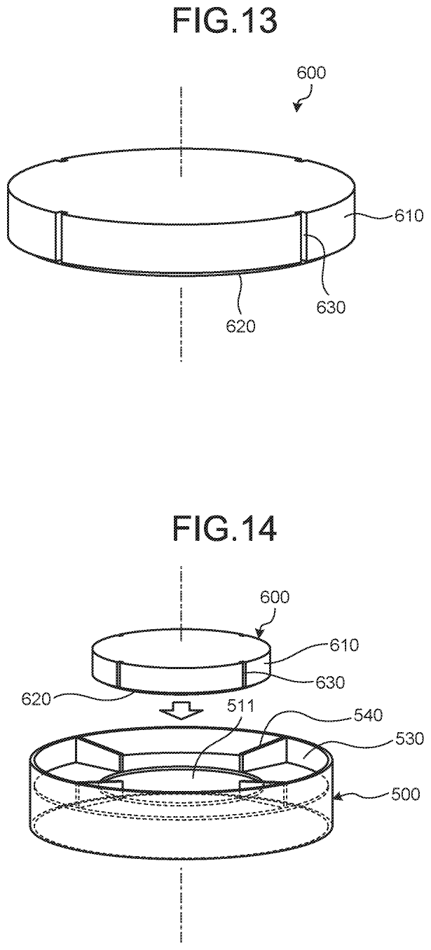

FIG. 11 is a top view of the mount cap 600. FIG. 12 is a side view of the mount cap 600. FIG. 13 is a perspective view schematically illustrating the mount cap 600. Further, in the first embodiment, the mount cap 600 serves as a cap.

The mount cap 600 illustrated in FIGS. 11 to 13 is detachably mounted in the mount portion 420 of the interchangeable lens 400. The mount cap 600 includes a main body 610 and the annular portion 620. The main body 610 and the annular portion 620 are integrated by injection molding.

The main body 610 which is fitted to the ribs 540 of the first lid member 500 is configured such that grooves 630 are provided in the side surface in a predetermined interval.

The annular portion 620 has the outer diameter which is matched to the inner diameter of the aperture 511 of the first lid member 500. The annular portion 620 is freely inserted to the aperture 511 of the first lid member 500, and is mounted to be freely mounted in the mount portion 420 of the interchangeable lens 400.

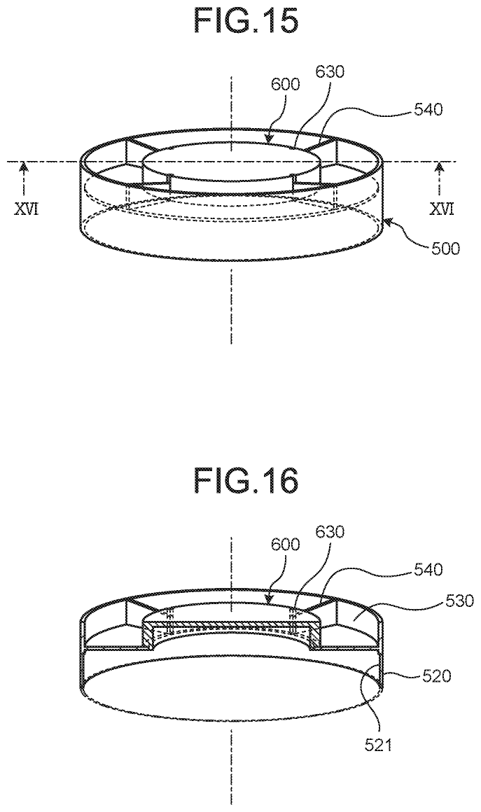

The mount cap 600 thus configured is inserted to the aperture 511 of the first lid member 500 as illustrated in FIGS. 14 to 16. In this case, the mount cap 600 is regulated in its movement when the groove 630 is fitted to the rib 540 of the first lid member 500.

Method of Storing Interchangeable Lens Storage Case System

Next, the method of storing the interchangeable lens 400 in the interchangeable lens storage case system 1 will be described using FIG. 1.

First, the user mounts the lens cap 300 to the other-end portion 410 of the interchangeable lens 400, then sets the mount portion 420 of the interchangeable lens 400 to pass through the aperture 511 of the first lid member 500 so as to make the mount portion 420 of the interchangeable lens 400 abut on the reception portion 510 of the first lid member 500.

Subsequently, the user fits the mount cap 600 to the mount portion 420 of the interchangeable lens 400 while rotating the mount cap in a state where the mount portion 420 of the interchangeable lens 400 passes through the aperture 511 of the first lid member 500. In this case, the user inserts the mount portion 420 of the interchangeable lens 400 from the aperture 511, and fixes the reception portion 510 of the first lid member 500 in a state of being interposed between the mount cap 600 and the interchangeable lens 400 so as to fix the interchangeable lens 400 while pressing to the reception portion 510 of the first lid member 500. With this configuration, the interchangeable lens 400 can be fixed in a state of being suspended.

Thereafter, the user stores the interchangeable lens 400 fixed to the first lid member 500 while pressing toward the case main body 100 where the buffer member 200 is stored.

Then, the user rotates the first lid member 500 to fit the positioning portion 520 of the first lid member 500 and a fitting portion 102 of the case main body 100. In this case, the buffer member 200 biases the interchangeable lens 400 from the other-end portion 410 toward the first lid member 500. As a result, the interchangeable lens 400 of the suspended state is grasped by the first lid member 500 and the buffer member 200, and regulated in its movement in the case main body 100. With this configuration, it is possible to buffer an impact on the interchangeable lens 400.

According to the first embodiment described above, when the interchangeable lens 400 is stored in the case main body 100, the mount portion 420 is inserted to the aperture 511 of the first lid member 500, and the reception portion 510 of the first lid member 500 is interposed between the mount cap 600 and the interchangeable lens 400. In this state, the mount cap 600 is mounted in the mount portion 420 to press and fix the interchangeable lens 400 to the reception portion 510 of the first lid member 500. Therefore, the interchangeable lens 400 is easily detached and attached. The interchangeable lens 400 can be made compact and can be carried with safety.

In addition, according to the first embodiment, the length of the longitudinal direction of the case main body 100 is larger than the length of the longitudinal direction of the interchangeable lens 400, so that the interchangeable lens 400 can be stored in the case main body 100 in the suspended state.

In addition, according to the first embodiment, the first lid member 500 is provided with the rib 540 which guides the mount cap 600 to a predetermined position and performs the rotation stop of the mount cap 600. Therefore, it is possible to prevent that the mount cap 600 rotates by an external force.

In addition, according to the first embodiment, the regulation portion 512 is provided on the rear surface side of the reception portion 510 of the first lid member 500 to regulate the movement of the interchangeable lens 400 onto the rear surface side. Therefore, it is possible to prevent that the interchangeable lens 400 moves in the case main body 100.

In addition, according to the first embodiment, the buffer member 200 is provided in the case main body 100, and the interchangeable lens 400 is biased toward the first lid member 500 and interposed between the first lid member 500 and the buffer member 200 to regulate the movement in the case main body 100. Therefore, it is possible to buffer an impact on the interchangeable lens 400.

### First Modification of First Embodiment

Next, a first modification of the first embodiment will be described. The first modification of the first embodiment is different from the configuration of the case main body 100 and the first lid member 500 according to the first embodiment. Further, the first modification of the first embodiment includes a second lid member in addition to the configuration of the interchangeable lens storage case system 1 according to the first embodiment. In the following, the same configurations as the interchangeable lens storage case system 1 according to the first embodiment will be attached with the same symbol, and the description thereof will be omitted.

Configuration of Lens Storage Case System

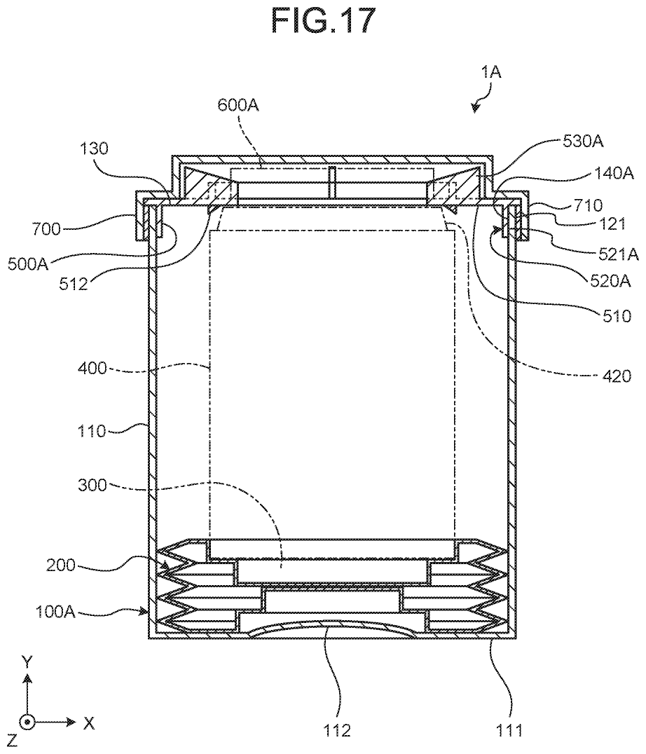

FIG. 17 is a cross-sectional view of the interchangeable lens storage case system according to the first modification of the first embodiment. An interchangeable lens storage case system 1A illustrated in FIG. 17 includes a case main body 100A and a first lid member 500A instead of the case main body 100 and the first lid member 500 according to the first embodiment. Further, the interchangeable lens storage case system 1A includes a second lid member 700 which fixes the first lid member 500A to the case main body 100A.

Configuration of Case Main Body

First, the configuration of the case main body 100A will be described.

In addition to the configuration of the case main body 100 according to the first embodiment, the case main body 100A illustrated in FIG. 17 is provided with a groove 140A on an inner peripheral side of the aperture 130 to fit the first lid member 500A.

Configuration of First Lid Member

Next, the configuration of the first lid member 500A will be described.

The first lid member 500A illustrated in FIG. 17 includes the reception portion 510, a positioning portion 520A, and the storage portion 530. The reception portion 510, the positioning portion 520A, and the storage portion 530 are integrated by injection molding.

The positioning portion 520A is provided on the rear surface side of the reception portion 510, and is fitted to the case main body 100A. The positioning portion 520A is formed in a cylindrical shape, and includes a groove 521A which is fitted to a groove 140A of the case main body 100A. The positioning portion 520A has an outer diameter smaller than the inner diameter of the case main body 100A.

Configuration of Second Lid Member

Next, the configuration of the second lid member 700 will be described.

The second lid member 700 fixes the first lid member 500A to the case main body 100A. The second lid member 700 includes a fitting portion 710 which is fitted to the groove 140A of the case main body 100A. The second lid member 700 is fitted to the groove 140A of the case main body 100A, and thus fixes the first lid member 500A to the case main body 100A.

According to the first modification of the first embodiment described above, the similar effects to those of the first embodiment are obtained. The first lid member 500A is fixed to the case main body 100A such that the second lid member 700 covers the first lid member 500A. Therefore, it is possible to prevent that an impact is applied to the first lid member 500A at the time of conveying.

### Second Embodiment

Next, a second embodiment will be described. In the first embodiment, the first lid member 500 is stored in the case main body 100 in a state of being interposed between the interchangeable lens 400 and the mount cap 600. However, in the second embodiment, the interchangeable lens is grasped by the first lid member and the buffer member. In the following, the same configurations as those of the interchangeable lens storage case system 1 according to the first embodiment will be attached with the same symbol, and the detailed description will be appropriately omitted.

Configuration of Interchangeable Lens Storage Case System

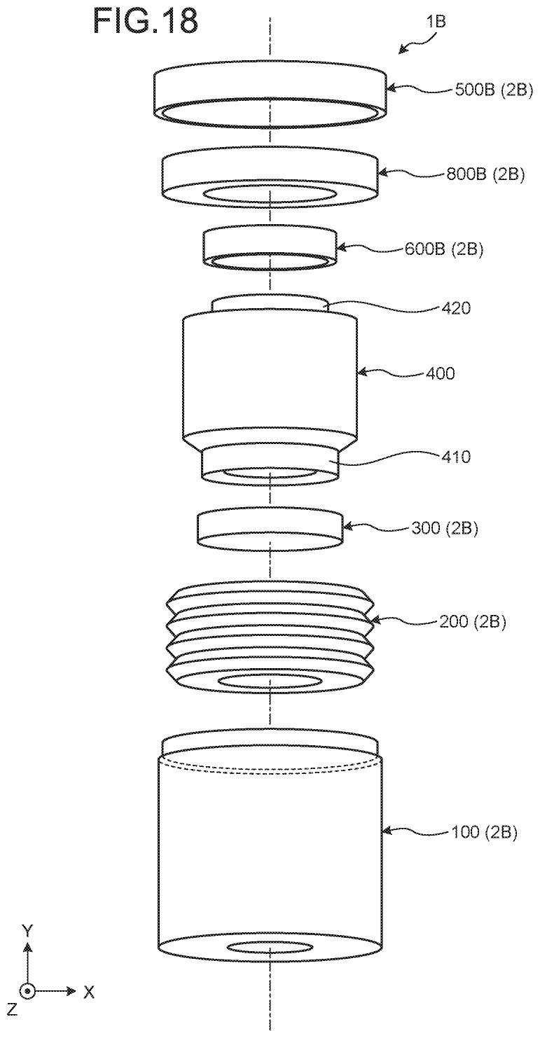

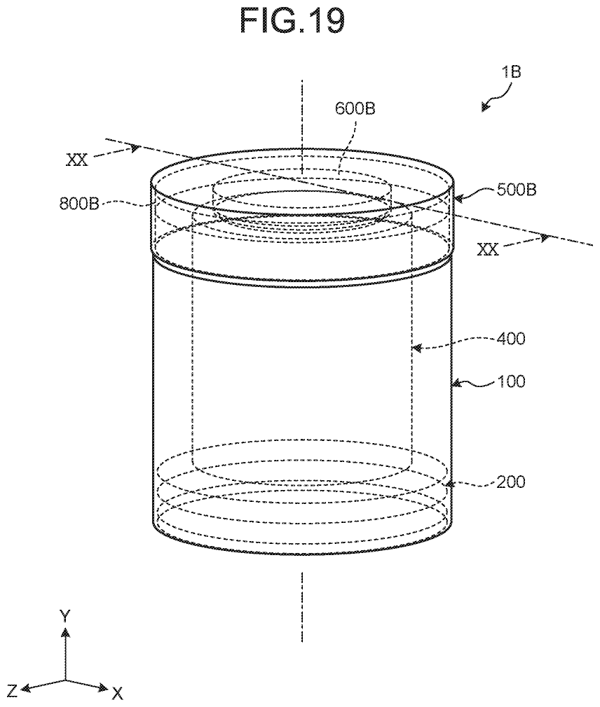

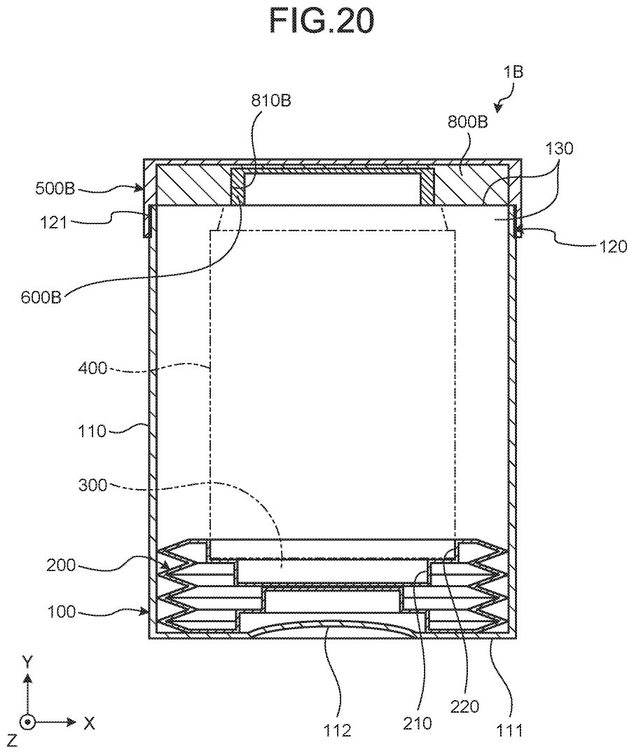

FIG. 18 is an assembly perspective view of an assembly perspective view of an interchangeable lens storage case system according to a second embodiment. FIG. 19 is a perspective view schematically illustrating a configuration of the interchangeable lens storage case system according to the first embodiment. FIG. 20 is a cross-sectional view taken along line XX-XX of FIG. 19.

An interchangeable lens storage case system 1B illustrated in FIGS. 18 to 20 includes a lens storage case 2B instead of the interchangeable lens storage case 2. The lens storage case 2B includes a mount cap 600B and a first lid member 500B instead of the mount cap 600 and the first lid member 500 of the interchangeable lens storage case 2 according to the first embodiment. Further, the lens storage case 2B includes a mount cap reception portion 800B.

Configuration of Mount Cap

First, the configuration of the mount cap 600B will be described.

The mount cap 600B is formed in a bottomed cylindrical shape. The mount cap 600 is detachably fixed to the mount portion 420 of the interchangeable lens 400.

Configuration of First Lid Member

Next, the configuration of the first lid member 500B will be described.

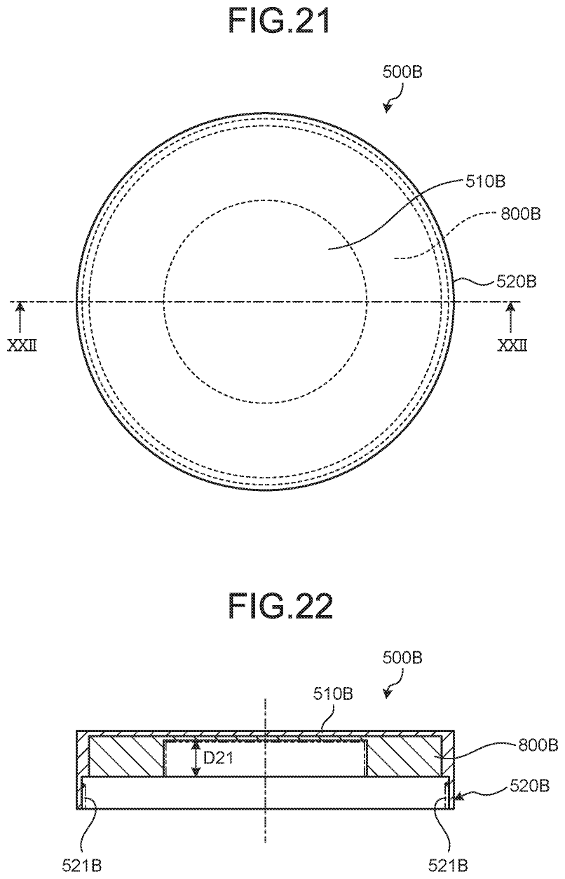

FIG. 21 is a top view of the first lid member 500B. FIG. 22 is a cross-sectional view taken along line XXII-XXII.

The first lid member 500B illustrated in FIGS. 18 to 22 stores the mount cap reception portion 800B where the mount cap 600B is inserted, and is fitted and fixed to the groove 121 of the case main body 100. The first lid member 500B includes a storage portion 510B which stores the mount cap 600B and the mount cap reception portion 800B, and a fitting portion 520B in which the groove 521 is provided to fit the groove 121 of the case main body 100. The storage portion 510B and the fitting portion 520B are integrated by injection molding.

Configuration of Mount Cap Reception Portion

Next, the configuration of the mount cap reception portion 800B will be described.

The mount cap reception portion 800B illustrated in FIGS. 18 to 22 is formed of an elastic member, and is formed in a bottomed cylindrical shape. The mount cap reception portion 800B is bonded to the first lid member 500B. The mount cap reception portion 800B includes a storage portion 810B which stores the mount cap 600B. The storage portion 810B has an inner diameter which is almost matched to the outer diameter of the mount cap 600B. Further, a height D21 in the vertical direction of the storage portion 810B is almost matched to the thickness of the mount cap 600B.

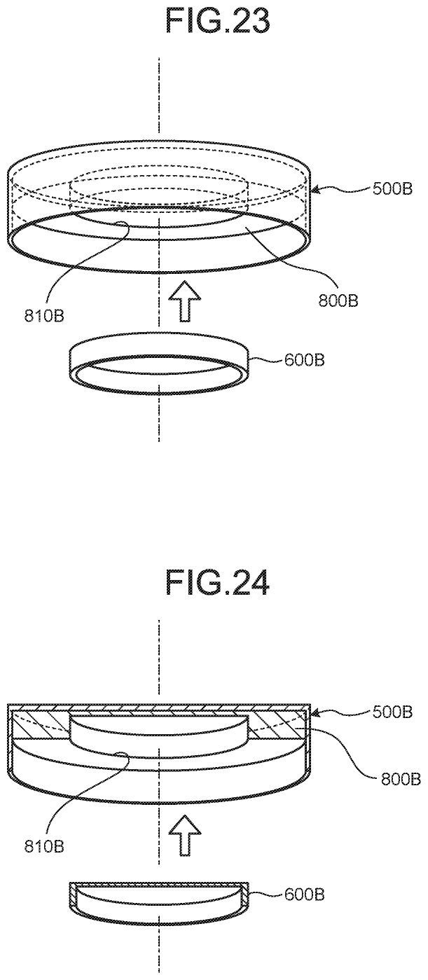

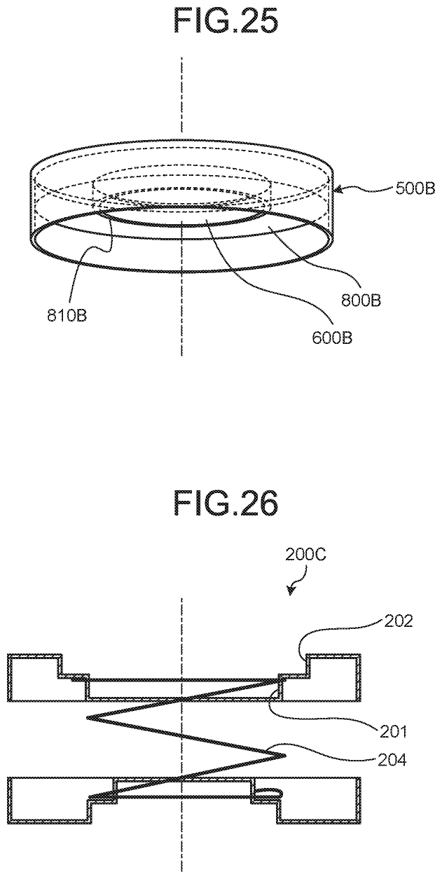

The first lid member 500B and the mount cap reception portion 800B thus configured are configured such that the mount cap 600B is inserted to the storage portion 810B of the mount cap reception portion 800B as illustrated in FIGS. 23 to 25. Then, the user fits the first lid member 500B to the groove 121 of the case main body 100 to fix the first lid member 500B to the case main body 100. With this configuration, the mount cap reception portion 800B exerts the buffering effect by being bonded to the first lid member 500B. In other words, according to the second embodiment, the first lid member 500B and the mount cap reception portion 800B are used so that not only the impact in either direction but also the impact from any direction can be absorbed.

Method of Storing Interchangeable Lens Storage Case System

Next, the method of storing the interchangeable lens 400 in the interchangeable lens storage case system 1 will be described using FIG. 18.

First, the user mounts the lens cap 300 and the mount cap 600B to the interchangeable lens 400, and then places the interchangeable lens 400 in a first lens receiving portion 201 of the buffer member 200 stored in the case main body 100 so as to face the lens cap 300.

Subsequently, the user inserts the mount cap 600B to the storage portion 810B of the mount cap reception portion 800B bonded to the first lid member 500B, and fixes the first lid member 500B to the case main body 100 by rotating and pressing the first lid member 500B. As a result, the interchangeable lens 400 is set to be grasped by the first lid member 500B and the buffer member 200 so as to be regulated from moving in the case main body 100. Further, an impact on the interchangeable lens 400 from the outside is absorbed by the first lid member 500B and the mount cap reception portion 800B. With this configuration, it is possible to buffer an impact on the interchangeable lens 400.

According to the second embodiment described above, the interchangeable lens 400 can be easily detached, and the interchangeable lens 400 can be made compact and carried with safety.

### Modifications of First and Second Embodiments

In the first and second embodiments, the buffer member 200 is formed in a bellows shape, but can be appropriately changed. FIG. 26 is a cross-sectional view for schematically describing a buffer member according to a modification of the first and second embodiments.

A buffer member 200C illustrated in FIG. 26 includes a biasing member 204 which biases the first lens receiving portion 201 toward an aperture 103 of the case main body 100 in addition to the first lens receiving portion 201 and a second lens receiving portion 202. The biasing member 204 is realized using a spring for example.

According to the modifications of the first and second embodiments described above, the interchangeable lens 400 can be easily detached, and the interchangeable lens 400 can be made compact and carried with safety.

### Other Embodiments

A plurality of components disclosed in the interchangeable lens storage case system according to the embodiments of this disclosure may be combined appropriately to form various embodiments. For example, some components may be omitted from all the components described in the interchangeable lens storage case system according to the embodiments of this disclosure. Further, the components described in the interchangeable lens storage case system according to the embodiments of this disclosure may be combined appropriately.

In addition, in the interchangeable lens storage case system according to an embodiment of this disclosure, the “portions” may be replaced with “means” or “members”. For example, the buffer member may be replaced with a stretchable portion or a stretchable means.

Hitherto, some embodiments of the application have been described in detail, but these are given as merely exemplary. The disclosure may be implemented in various modifications and improved other forms based on the knowledge of a person skilled in the art including the embodiments described in this disclosure.

Further, this technology can be taken from the following configurations.

(1)

A lens storage case including:

a case main body configured to store an interchangeable lens;

a first lid member detachably attached to an aperture of the case main body; and

a cap detachably attached to one-end portion of the interchangeable lens,

wherein the first lid member includes a reception portion which abuts on the interchangeable lens and includes an aperture to which the one-end portion is freely inserted, and is configured to insert the one-end portion to the aperture of the reception portion when the interchangeable lens is stored in the case main body, and mount the cap to the one-end portion in a state where the reception portion is interposed between the cap and the interchangeable lens so as to fix the interchangeable lens to the reception portion.

(2)

The lens storage case according to (1),

wherein the case main body is configured such that a length in a longitudinal direction is longer than a length in a longitudinal direction of the interchangeable lens.

(3)

The lens storage case according to (1) or (2),

wherein the first lid member further includes

a rib configured to guide the cap to a predetermined position, and regulate a rotation of the cap.

(4)

The lens storage case according to any one of (1) to (3),

wherein the first lid member further includes
a regulation portion provided on a rear surface side of the reception portion, and configured to regulate a movement of the interchangeable lens.
   (5)

The lens storage case according to any one of (1) to (4), further including:

a buffer member provided inside the case main body, and configured to bias the interchangeable lens toward the first lid member.

(6)

The lens storage case according to (5),

wherein the buffer member further includes

a storage portion configured to store other-end portion of the interchangeable lens, and regulate a movement of the interchangeable lens.

(7)

The lens storage case according to (5) or (6),

wherein the buffer member is formed in a bellows shape.

(8)

The lens storage case according to (5) or (6),

wherein the buffer member is a spring.

(9)

The lens storage case according to any one of (1) to (8), further including:

a second lid member having an inner diameter larger than an outer diameter of the first lid member, and the second lid member being fitted to an outer peripheral side of the case main body in a state where the first lid member is fitted to an aperture of the case main body.

(10)

A lens storage case, including:

a case main body configured to store an interchangeable lens;

a cap detachably attached to one-end portion of the interchangeable lens;

a first lid member configured to store the cap inside, the first lid member being detachably attached to an aperture of the case main body; and

a buffer member provided in the case main body, and configured to bias the interchangeable lens toward the first lid member.

(11)

A cap including:

an annular portion formed in an annular shape, and fitted to one-end portion of an interchangeable lens; and

a main body having an outer diameter larger than an outer diameter of the annular portion,

wherein the main body includes a groove which is a rib provided in a first lid member, the first lid member being detachably attached to an aperture of a case main body configured to store the interchangeable lens, the first lid member being configured to guide the main body to a predetermined position and being fitted to the rib to regulate a rotation of the main body.

(12)

A lens storage case system including:

an interchangeable lens detachably attached to an image capture device;

a case main body configured to store the interchangeable lens;

a first lid member detachably attached to an aperture of the case main body; and

a cap detachably attached to one-end portion of the interchangeable lens,

wherein the first lid member includes
a reception portion abutting on the interchangeable lens, and
an aperture to which the one-end portion is freely inserted, and

the first lid member is configured to insert the one-end portion to the aperture of the reception portion when the interchangeable lens is stored in the case main body, and mount the cap to the one-end portion in a state where the reception portion is interposed between the cap and the interchangeable lens so as to fix the interchangeable lens to the reception portion.

In this way, this disclosure may include various embodiments which are not described herein, and various changes in design may be made within the scope of specified technical ideas.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An interchangeable lens storage case for storing an interchangeable lens using a cap mounted in one-end portion of the interchangeable lens, the interchangeable lens storage case comprising:
a case main body; and
a first lid member positioned and fixed to an aperture of the case main body, the first lid member including
an aperture passing through the one-end portion of the interchangeable lens, and
a reception portion pressed and fixed to the interchangeable lens in an outer peripheral portion of the aperture,
wherein the reception portion is fixed by being interposed between the interchangeable lens and the cap when the cap is fixed to the interchangeable lens.

2. The interchangeable lens storage case according to claim 1, wherein the first lid member includes a positioning portion to be positioned in the case main body.

3. The interchangeable lens storage case according to claim 1, further comprising:
a second lid member configured to fix the first lid member to the case main body,
wherein the first lid member is configured to fix the interchangeable lens in a suspended state.

4. The interchangeable lens storage case according to claim 1, wherein the first lid member is provided with a rib which guides the cap and performs a rotation stop.

5. The interchangeable lens storage case according to claim 1, further comprising:
a buffer member disposed between a bottom of the case main body and other-end portion side of the interchangeable lens.

6. The interchangeable lens storage case according to claim 5, wherein the buffer member is folded by a predetermined amount to change a dimension based on a dimension between the bottom of the case main body and the other-end portion of the interchangeable lens.

7. An interchangeable lens storage case, comprising:
a case main body configured to store an interchangeable lens;
a cap detachably attached to one-end portion of the interchangeable lens;
a first lid member configured to store the cap inside, and detachably attached to an aperture of the case main body; and
a buffer member provided in the case main body, and configured to bias the interchangeable lens toward the first lid member.

8. A cap, including:
an annular portion formed in an annular shape, and fitted to one-end portion of an interchangeable lens; and
a main body having an outer diameter larger than an outer diameter of the annular portion,
wherein the main body includes a groove which is a positioning portion provided in a first lid member, the first lid member being detachably attached to an aperture of a case main body which can store the interchangeable lens, and configured to guide the main body to a predetermined position and is fitted to a rib to stop a rotation of the main body.

9. An interchangeable lens storage case system for storing an interchangeable lens using the interchangeable lens detachably attached to an image capture device and a cap mounted in one-end portion of the interchangeable lens, the interchangeable lens storage case system comprising:
a case main body; and
a first lid member positioned and fixed to an aperture of the case main body, and the first lid member including
an aperture passing through the one-end portion of the interchangeable lens, and
a reception portion pressed and fixed to the interchangeable lens in an outer peripheral portion of the aperture,
wherein the reception portion is fixed by being interposed between the interchangeable lens and the cap when the cap is fixed to the interchangeable lens.
